(19) United States
(12) Patent Application Publication
(10) Pub. No.: US 2011/0078933 A1
(43) Pub. Date: Apr. 7, 2011

(54) ELECTRONIC LICENSE PLATE AND INFORMATION PROCESSING SYSTEM

(76) Inventors: Jason J. Lukawitz, Nolensville, TN (US); Robert C. Stevens, Antioch, TN (US)

(21) Appl. No.: 12/572,464

(22) Filed: Oct. 2, 2009

(51) Int. Cl. B60R 13/10; G01C 21/00; G06F 15/16; H04L 9/32

(52) U.S. Cl. 40/204; 40/200; 701/213; 709/219; 713/168

(57) ABSTRACT

An electronic license plate and information processing system allows for a vehicle license plate to serve not only the purpose of identifying a specifically associated vehicle, but to also serve as a media for publishing temporal messages specifically associated with the vehicle or its locale. A license plate assembly consisting of a microprocessor chip in communication with a radio frequency transponder serves to control a light emitting diode matrix or other similar display and to publish messages therethrough in accordance with data and commands received from the transponder. The various information sources, including a department of motor vehicles, law enforcement, insurance records, and public service agencies are capable of communicating with the electronic license plate through encrypted transmission. The control server is interposed between these various sources and the interactive license plate for effecting the desired transmission and receipt of data and commands. The license plate assembly itself is tamper resistant and tamper evident. With the license plate assembly being dynamic and interactive, its capabilities for publishing information and messages under control of various authorized sources is extensive.

### TECHNICAL FIELD

The invention herein resides in the art of display devices and, more particularly, to display devices in the nature of vehicle license plates. Specifically, the invention relates to an interactive vehicle license plate adapted for communication with various sources to effect desired and requisite changes in the display of the license plate itself. In a specific embodiment of the invention, the invention relates to a vehicle license plate system allowing for remote augmentation and authorization of display data, allowing a vehicle license plate to serve as an information distribution media when linked to a central communication point or control server.

### BACKGROUND ART

Vehicle license plates are commonly used throughout the various states as a means of vehicle identification and verification that the requisite taxes associated with the vehicle have been paid. In common practice, these license plates are of a fixed metallic nature, with the only indicia thereon that may be changed periodically being validation stickers that are annually applied to indicate renewal. While the license plates may carry various messages, such as state mottos and a wide range of vanity plate messages, those messages are typically fixed and not given to modification except upon a change of the license plate itself.

Those traveling the roadways are familiar with messages conveyed to them by signage and the like along the roadway. That signage is typically in the form of advertising and of minimal social value beyond that inherent to advertising. Society would, however, benefit from a means of visual communication to roadway users to provide them with information of immediate usefulness while upon the roadway. Particularly, information peculiar to a particular vehicle or geographic region could be of particular value to roadway travelers when in that region or in the proximity of the particular vehicle. Such information may be of specific interest to law enforcement officers and safety personnel, in addition to the public at large.

There is a need in the art for a structure and methodology for conveying to roadway users information that is specific to particular vehicles and geographic regions. Since every vehicle has a license plate, the invention contemplates that such license plates may be made interactive with appropriate agencies to allow the license plates to serve as mobile billboards to convey information regarding the vehicle, its owner/occupant, or activities in the general geographic region in which the vehicle is presently operating. By configuring license plates as active display screens, roadway communications can be greatly enhanced in real time, providing a broad range of public good. Indeed, there is a need in the art for a system and methodology that would allow for the publication of messages communicating that an associated vehicle is stolen, was involved in a crime, that the vehicle was associated with an “Amber Alert” incident, that the vehicle is presently uninsured, that the registration itself has lapsed, or the like. As to messages regarding specific geographical regions as might be determined by a Global Positioning System (“GPS”), the messages might also include notification of road and traffic conditions. Other vehicle-specific messages might include “scales drive-by” for commercial vehicles, the ability to track logged hours on the road and publish an alert when the authorized hours have been exceeded, an indication that the legal weight has been exceeded, and the like.

### DISCLOSURE OF THE INVENTION

In light of the foregoing, it is a first aspect of the invention to provide an electronic vehicle license plate and information processing system that is interactive with various authorized agencies.

Another aspect of the invention is the provision of an electronic vehicle license plate and information processing system that is conducive to the publication of various messages and notices, being readily changed and adapted for near real time publication.

Yet another aspect of the invention is the provision of an electronic vehicle license plate and information processing system that is customizable to satisfy user's desires.

Still a further aspect of the invention is the provision of an electronic vehicle license plate and information processing system that is secure in implementation, being tamper resistant and given only to augmentation by authorized agencies.

Yet a further aspect of the invention is the provision of an electronic vehicle license plate and information processing system that includes a secure power source, remaining active even if the vehicle power source is unavailable.

Still a further aspect of the invention is the provision of an electronic vehicle license plate and information processing system that is of a wireless nature, being given to radio frequency communication with authorized agencies.

Another aspect of the invention is the provision of an electronic vehicle license plate and information processing system that is dynamic in nature, given to changes in near real time, and allowing for publication of messages peculiar to the vehicle, its owner/occupant, or the geographic region in which the vehicle is present.

An additional aspect of the invention is the provision of an electronic vehicle license plate and information processing system that is conducive to implementation with a broad range of vehicles and licensing jurisdictions.

A further aspect of the invention is the provision of an electronic vehicle license plate and information processing system which is conducive to being retrofitted to existing automobiles, as well as being integrated into new designs.

Still another aspect of the invention is the provision of an electronic vehicle license plate and information processing system that utilizes highly secure encryption in its communication, substantially eliminating the likelihood of tampering or unauthorized interference.

Still another aspect of the invention is the provision of an electronic vehicle license plate and information processing system that is tamper evident, providing notification upon any attempt to tamper with or defeat the communication system.

The foregoing and other aspects of the invention that will become apparent as the detailed description proceeds are achieved by an electronic license plate and information processing system, comprising: a license plate assembly adapted for secured attachment to a vehicle; at least one data and command source; a control server interposed between said license plate assembly and said at least one data and command source, said control server effecting transmission of data and commands with said license plate assembly and said data and command source; and wherein said license plate assembly is dynamic and interactive, responding to data and commands from said data and command source to effect a controlled publication thereon.

Other aspects of the invention that will become apparent herein are attained by a method for regulating and controlling the publication of information on a dynamic interactive vehicle license plate, comprising; transmitting information from an information source to a control server; transmitting said information from said control server to the dynamic interactive vehicle license plate; and publishing a display on said dynamic interactive vehicle license plate in response to said information.

### DESCRIPTION OF DRAWINGS

For a complete understanding of the various aspects, structures and techniques of the invention reference should be made to the following detailed description and accompanying drawings wherein:

FIG. 1 is an exploded illustration of the constituent elements of the electronic vehicle license plate of the invention;

FIG. 2, comprising FIGS. 2A and 2B, presents a front perspective view of an electronic vehicle license plate made in accordance with the invention, showing a real time message being published thereon by flashing;

FIG. 3 is a block diagram of the electronic vehicle license plate and information processing system made in accordance with the invention;

FIG. 4 is a flow chart demonstrating the operation of the electronic vehicle license plate and information processing system of the invention;

FIG. 5 is a flow chart showing the power interruption correction process;

FIG. 6 is a side sectional view of the electronic vehicle license plate of the invention, shown retrofit to an existing vehicle;

FIG. 7 is a side sectional view of the electronic vehicle license plate of the invention, shown as original equipment in a new vehicle installation; and

FIG. 8 is a block circuit schematic of the control circuitry of the electronic vehicle license plate of the invention.

### DETAILED DESCRIPTION OF PREFERRED EMBODIMENT

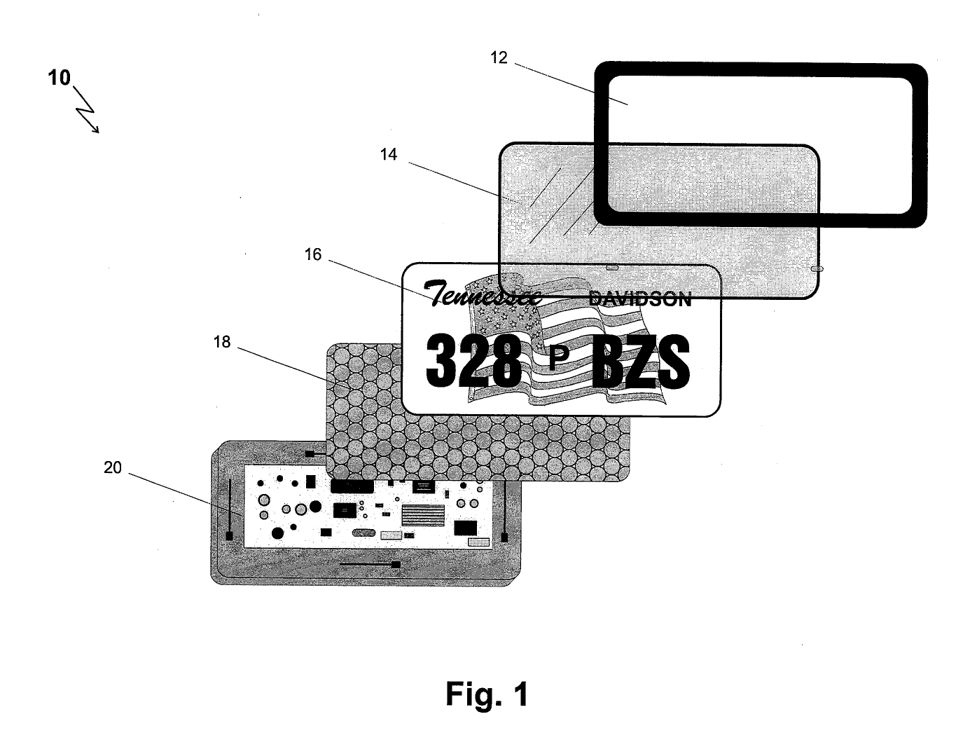

Referring now to the drawings and more particularly FIG. 1, it can be seen that an interactive license plate assembly made in accordance with the invention is designated generally by the numeral 10. The assembly 10 includes a frame 12, which may be of various natures, such as a channel construction. Received within the frame 12 is a protective cover 14, preferably of high clarity such as polycarbonate or similar material. The clear protective cover 14 shields and protects a light emitting diode (“LED”) display screen 16. It will be appreciated that the display or matrix may be of any suitable type or nature, but an organic LED assembly is preferred due to its low power consumption and clarity in ambient light. It is contemplated that a liquid crystal display or other medium may be used in place of an LED matrix. Immediately beneath the LED display 16 is a photovoltaic cell plate 18, as is well known and understood by those skilled in the art. Again, the photovoltaic cell plate 18 may be of any of various natures, the same being adapted to convert light energy to electric energy for either operating the plate assembly 10, or replenishing a rechargeable battery pack comprising an integral portion thereof. Finally, an electronic circuit board 20 is provided to regulate and control the display of the LED display screen 16. The electronic circuit board 20 preferably includes a rechargeable battery pack that is tied to and recharged by the photovoltaic cell plate 18 and the vehicle's battery. The board 20 further includes radio frequency (“RF”) receivers and transponders, along with a dedicated microprocessor chip for performing the necessary control functions. In operation, the license plate assembly 10 may be operated off of the vehicle battery, typically 12 volts, with necessary step-down voltage regulation. In the event of the loss of the vehicle battery power, the rechargeable battery pack of the electronic circuit board 20, replenished by the photovoltaic cell plate 18, may be sufficient for the necessary operation for a reasonable duration. It will be appreciated that the LED display 16, photovoltaic cell plate 18 and electronic circuit board 20 are all physically and electrically interconnected, as will be readily appreciated by those skilled in the art.

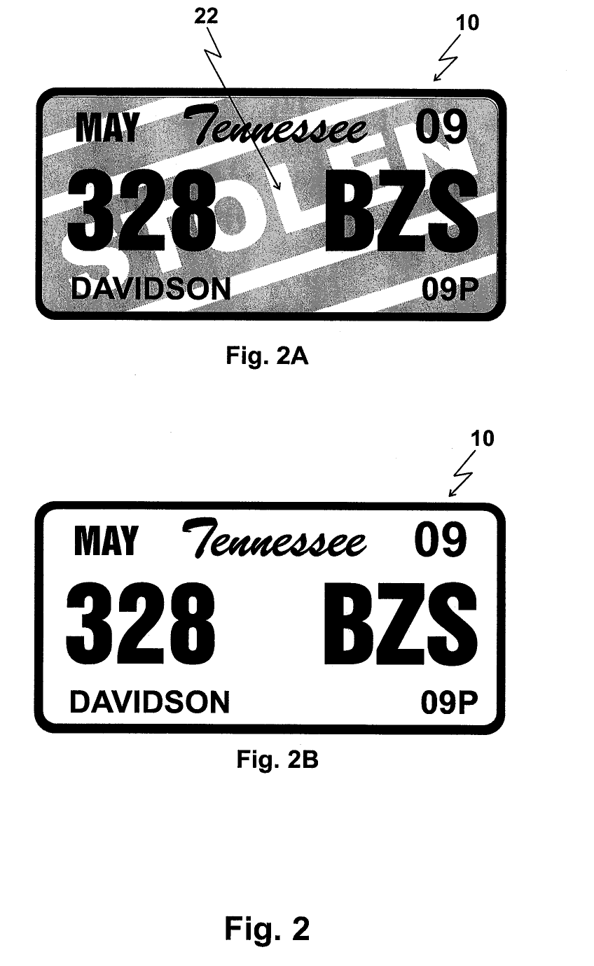

With reference now to FIG. 2, it can be seen that the interactive license plate assembly 10 displays a temporal or customized message 22, the same being processed by the electronic circuit board 20 for display on the LED display 16. In this case, the temporal message is “STOLEN.” The temporal message may be either static or dynamic, as desired. FIGS. 2A and 2B, taken in combination, show a flashing of the word “STOLEN” on the license plate 10, while it is contemplated that more complex messages may be streamed across the license plate—such as, “Reported Stolen . . . Report to Law Enforcement.” It will be appreciated that a wide variety of temporal or custom messages might be imparted to the vehicle license plate. As can be seen, absent the temporal message 22, the license plate 10 has all of the normal indicia required by the county and state of origin, including validation information and the like. It will be appreciated by those skilled in the art, that the temporal message could include a wide variety of declarations, such as “Uninsured Vehicle Proceed With Caution,” “Expired Registration,” “Involved in Abduction Report To Law Enforcement,” “Stolen Vehicle,” “Traffic Congestion Ahead,” “Hit and Run,” and the like. The nature and range of messages that might be imparted by various persons and authorized agencies, as will become apparent below, are rather endless.

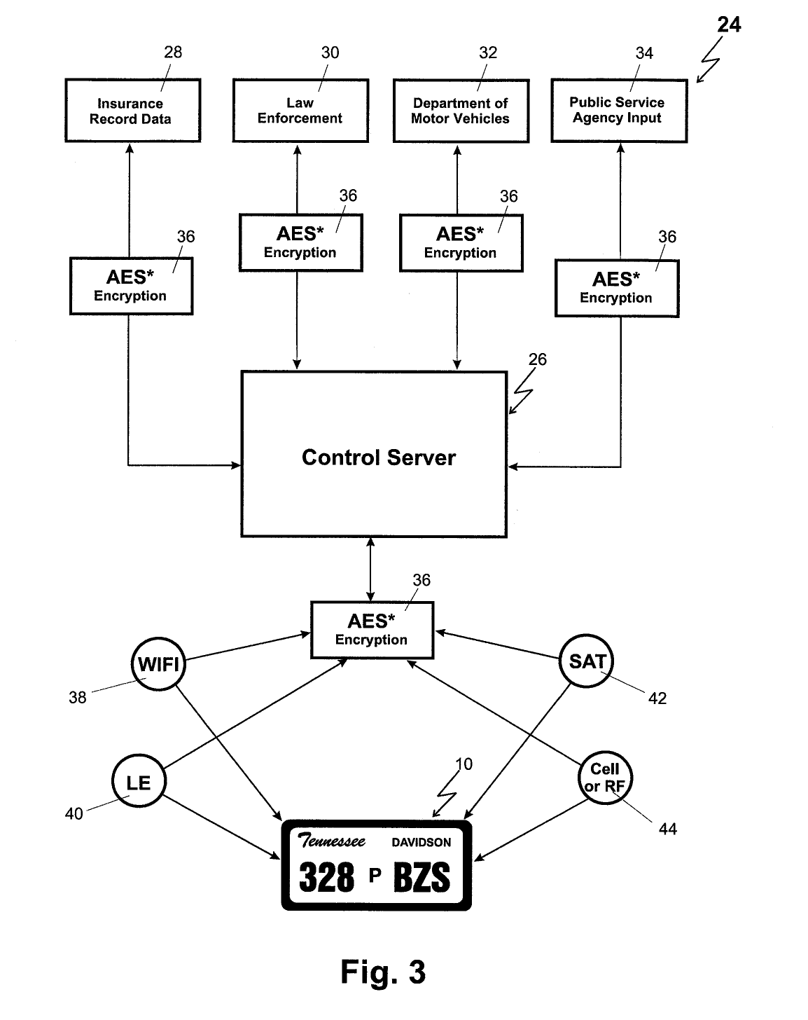

With reference now to FIG. 3, an appreciation may be obtained with regard to the digital plate communication system according to the invention, designated by the numeral 24. As shown, the heart of the system 24 is a control server 26, comprising a dedicated processor and communications equipment. The control server 26 is adapted to communicate between the license plate assembly 10 and the various data or information and control sources, which may be of various natures. One such data and control source is that of insurance records 28, another being law enforcement 30, still another being the Department of Motor Vehicles 32, and still another being any of various public service agencies 34. Each of the data sources 28-34 is capable of bidirectional communication with the control server 26 through appropriate encryption modules 36. The preferred encryption is the Advanced Encryption Standard (“AES”) which is a secure encryption technique which has been selected by the National Institute of Standards and Technology as a “Federal Information Processing Standard,” and by the National Security Agency for classified encryption use up to Top Secret level. AES is a fast data encryption algorithm with words ranging from 128 bits to 256 bits.

The control server 26 communicates not only with the data and information sources 28-34, but also the interactive license plate assembly 10, again through an appropriate AES module 36, and typically by radio frequency (RF) communication. The communication from the control server 26 to the license plate 10 may be by any suitable form of RF transmission such as Wi-Fi 38, law enforcement transmission 40, satellite 42, or spread spectrum technology 44. As noted, the communication is primarily unidirectional in each event, passing from the server 26 to the interactive license plate assembly 10 in the case of the transmission sources 38-42. It will be appreciated that RF is employed for indicating system failure or tampering. It will also be appreciated that communication from the license plate 10 back to the server 26 will typically be made for the purpose of sending a confirmation signal, confirming that the source data has been received and acted upon.

Before addressing the specifics of the further structure of the invention, an appreciation of the basic structure and operation should be obtained. As presented above, the invention contemplates the use of organic light emitting diode technology to display the methodology similar to that for computer screens or digital television, with the size, style, graphics and color of the image being substantially infinitely variable depending only on the specifications desired by the user.

The use of AES encryption with dual authentication protocol, such as a unique 256 bit rolling code encryption, ensures that the information received is in fact from an authorized reporting agency. As noted in FIG. 3, encryption occurs on all sides of the control server 26, whether sending or receiving.

Approved agencies for providing data and information to the license plate assembly 10 cover a wide range of data and information sources. To ensure that a license plate 10 receives only data and information intended for that license plate, each license plate 10 has a uniquely associated electronic serial number, which is proprietary to the software system communicating therewith. The electronic serial number, along with the rolling code encryption, serves to greatly frustrate and impede potential hackers. Moreover, each individual plate 10 has an associated random number generator as a component, that works in conjunction with the electronic serial number of each plate to guarantee that each plate has a unique number at all times, further preventing unauthorized access. Moreover, it is contemplated that the operating software of the invention will be such that each reported event from an authorized agency will receive a unique identifying number that can be used for future reference by such agency as may be needed for trials, certifications, or the like.

The invention contemplates that the battery voltage of the vehicle will typically operate a license plate assembly 10, when the vehicle is in operation. When the car ignition is turned off, the display is dimmed and powered by the vehicle's battery, or a battery pack on the electronic circuit board 20. When the license plate assembly 10 is in a power-save mode, the primary reduction of power consumption is realized as a result of the reduction of power necessary for energizing the LED display 16. Since the communication portion of the license plate assembly 10 requires far less power than the illumination portion, the various agencies may still communicate with the interactive license plate assembly 10 even in the power save mode.

As a portion of the instant invention, it is also provided that the interactive license plate assembly 10 is tamper-proof and disabled in the event of opening or attempt to disassemble the assembly 10, or disabled due to disconnection of power as by the cutting of cables. Reactivation of the assembly 10 may only be made by authorization from a controlling authority, such as a Department of Motor Vehicles, Law Enforcement or the like. The disabling of the plate assembly 10 does not, however, impact the operation of the vehicle in any way.

The invention further contemplates that when information is received by a particular license plate assembly 10, indicating need for corrective action, such as plate renewal, acquisition of insurance, or the like, the appropriate message may be sent by the appropriate agency to the plate data center which, through server 26, transmits to the plate assembly 10, with the message flashing or otherwise being made apparent through specific graphics or the like, to draw such situation to the attention of observers who may either notify the vehicle owner or an appropriate authority.

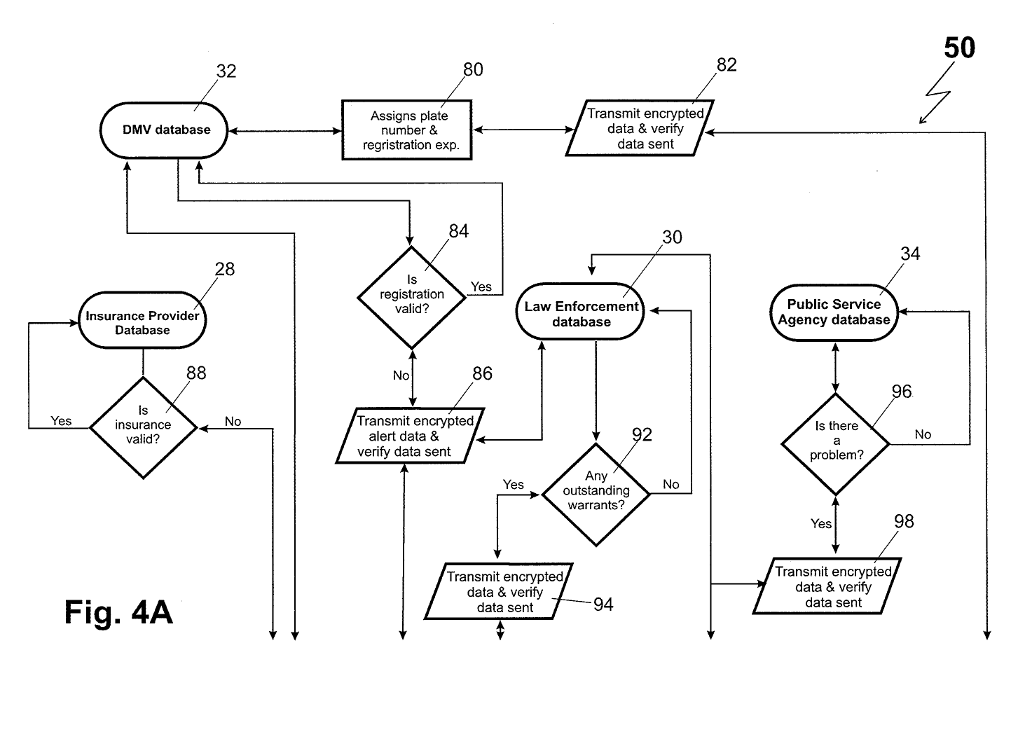

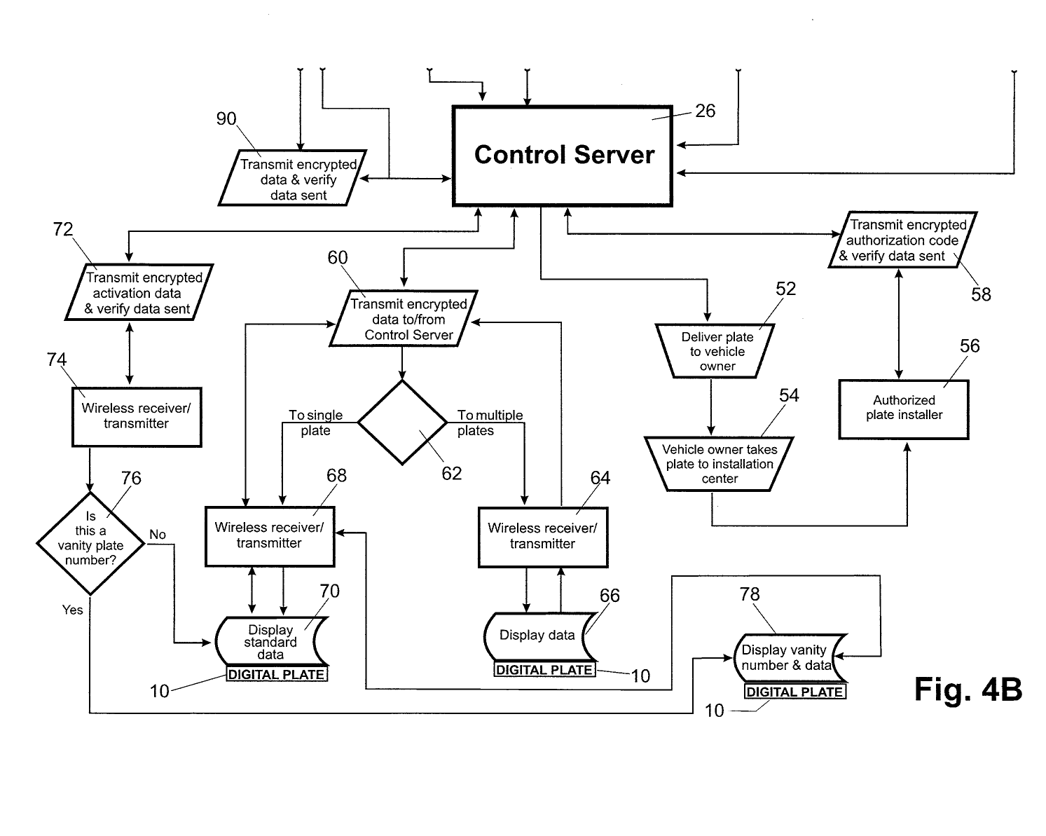

Referring now to FIG. 4, it can be seen that a method according to the invention is designated generally by the numeral 50. At the heart of the method 50 is the control server 26, operating to communicate with the digital plate 10 and the various sources 28-34.

Each plate has a uniquely associated electronic serial number. As shown, a new plate 10 may be placed into service with the DMV 32 sending an authorization to the control server 26 to associate that plate with a unique vehicle owner. The control server 26 downloads unique vehicle owner data to the plate 10, including a unique pin identification number (UPIN to be discussed below), which is then delivered to the vehicle owner as at 52. Upon receiving the plate 10, the vehicle owner takes the plate 10 to an installation center as at 54, where it is installed by an authorized plate installer at 56. The authorized plate installer uses tamper proof technology for the installation. At 58, the plate installer sends its authorization code to the control server 26 for activation. Transmission is sent back from the control server 26 to verify the sender. The control server 26 then uses the UPIN as the display number on the plate in the standard display plate (non-vanity) and as the database key for that plate. If the plate 10 is a vanity plate, requiring the standard display of the unique letter and number string to be replaced by a vanity string, then the unique letter and number string will be retained as the database key and the vanity string will be displayed on the plate. The control server 26 sends display information to the plate 10, and the plate is activated.

Upon receipt of data from any of the sources 28-34, the control server 26 encrypts the data with AES encryption and transmits the same as at 60. At 62, based on the data transmitted, the data is sent to either a single plate or a group of plates using wireless technology, communicating with the plates via the antennas or transponders maintained thereby in the respective circuit boards 20. If sent to a group of plates as at 64, the data is displayed as at 66 via the LED display of the associated plates 10.

If the data is intended for a single plate, the determination is made at 62 and the transmission is made as at 68, again using wireless technology as before. The LED display 16 of the associated plate 10 is altered as at 70, as a function of the data received from the control server 26.

Upon the event of new plate activation, the control server 26 encrypts the data and sends it to a wireless transponder as at 72, which is received at 74 and a determination is made at 76 as to whether the associated plate is a vanity plate. If it is not, the standard data is displayed upon the plate as at 70. If the plate is a vanity plate, the display of the vanity number and data is achieved as at 78 and imparted to the plate 10.

Attention will now be given to communications from the Department of Motor Vehicles database 32. When the DMV receives an application for registration from a vehicle owner, it assigns a unique plate identification number (“UPIN”) and a registration expiration date for the owner's vehicle at 80. This UPIN is sent by AES encryption to the control server 26, which sends back an encrypted signal for verification. When verification is received by the control server 26, the data is stored pending receiving an authorization code from an authorized installer of the plate for this UPIN. In this regard, reference is made to the process of steps 52-58, above. Alternatively, the invention contemplates that the UPIN may be assigned at the manufacturing facility for the vehicle itself. In such a case, the manufacturing facility may provide the DMV with a listing of UPIN's issued to vehicles in association with the vehicle identification number (“VIN”). The invention contemplates a coordination between the vehicle manufacturer and the DMV of UPIN's assigned to VIN's either before or after manufacture.

The DMV database 32 may also query whether a registration is valid as at 84. If it is valid, the process returns back to the DMV database with that acknowledgement. If not, an encrypted alert is sent to the control server 26 which initiates steps 60, 62, and 68-78 described above.

To ensure that a UPIN is always visible, as is the case with present fixed static plates, the invention contemplates that a fixed display of the UPIN may be placed in front of or behind the display screen 16. Preferably, with the display screen 16 being such that in the unpowered mode it is clear or transparent, any failure of the display screen 16, as by lack of power or the like, will result in exposure of an underlying fixed static plate displaying the UPIN.

With regard to communications with an insurance provider database 28, the insurance provider may query the database 28 to determine if insurance is current as at 88. If it is, no action is taken. If not, however, an encrypted alert is sent at 90 to the control server 26, which takes the necessary steps to publish the information to the plate 10 as by steps 60, 62, and 68-70.

In the event of communication with a law enforcement database 30, a determination may be made as at 92 as to any legal issues associated with a particular plate. If there are no such issues, no further action is taken. If there are legal issues, then encrypted data is verified and sent as at 94 and the control server 26 initiates steps 60, 62 and 68 to publish the appropriate information, warning, or other display on the associated plate 10. In the event that the message is to be transmitted to a number of plates, the process may proceed via steps 64, 66.

In communicating with public service agencies as at 34, a determination may be made as at 96 as to whether a problem exists that would require publication via a plate or selected grouping of plates. If no such issues exist as at 96, no further action is taken. If, however, such a situation does exist, encrypted data and verification is effected as at 98 with the control server 26. The control server 26 then initiates the process of steps 60, 62 and 68-70 in the case of a single plate, or steps 60 in the event that the publication is to be made to a selected group of plates.

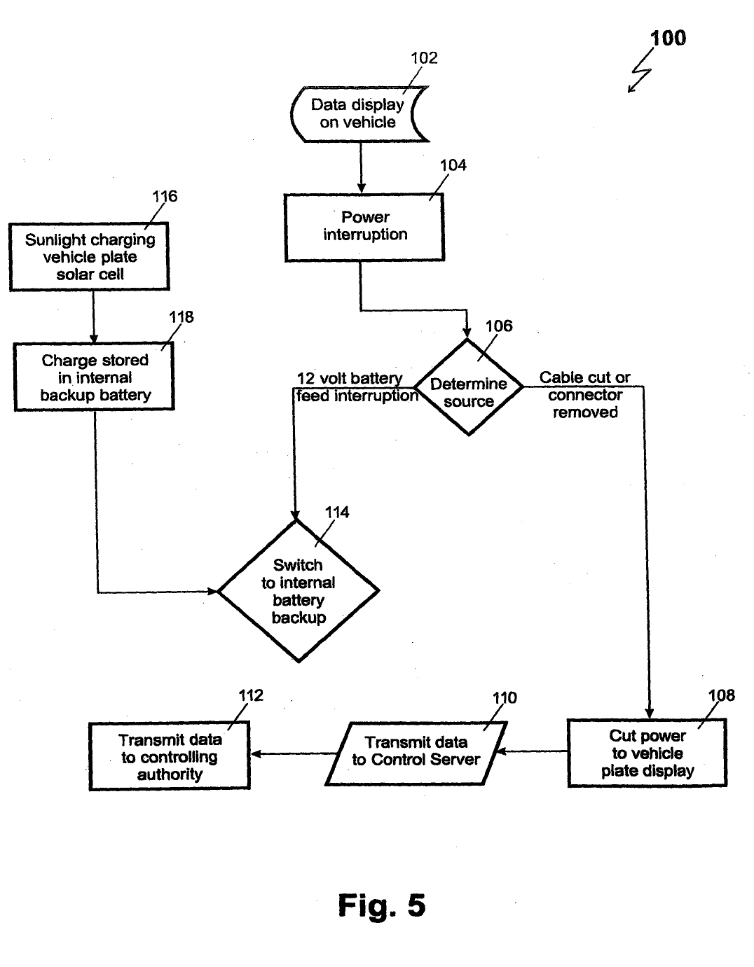

With reference now to FIG. 5, an appreciation can be obtained with regard to the security associated with the sensing of power interruption or tampering with plate assembly 10. The process is designated by the numeral 100 in FIG. 5, and contemplates a display of data on the vehicle plate as at 102. This data display necessarily requires the presence of appropriate power to energize the LED display 16 of the plate assembly 10. In the event of a power interruption as at 104, the determination is made at 106 as to the source of the interruption. If is determined at 106 that a power cable has been cut or a connector removed, power to the vehicle plate display is terminated as at 108 and data evidencing the same is transmitted to the control server 26 as at 110. The control server 26 then transmits data to the controlling authority such as law enforcement, DMV, or the like as at 112. It will, of course, be appreciated that the residual power remaining within the plate assembly 10 will be sufficient for the transmitting of data to the control server at step 110, following the termination of power application as at 108. If not, the steps 108, 110 may be reversed.

In the event that the source of power interruption is determined at 106 to be the result of the vehicle battery interruption or reduction in voltage, the electronic circuit board 20 may switch to the internal battery pack backup as at 114. In such event, the battery pack is switched to control of the license plate assembly 10 as at 118, the battery pack being charged by sunlight or other ambient light through the photovoltaic cell plate 18 as at 116.

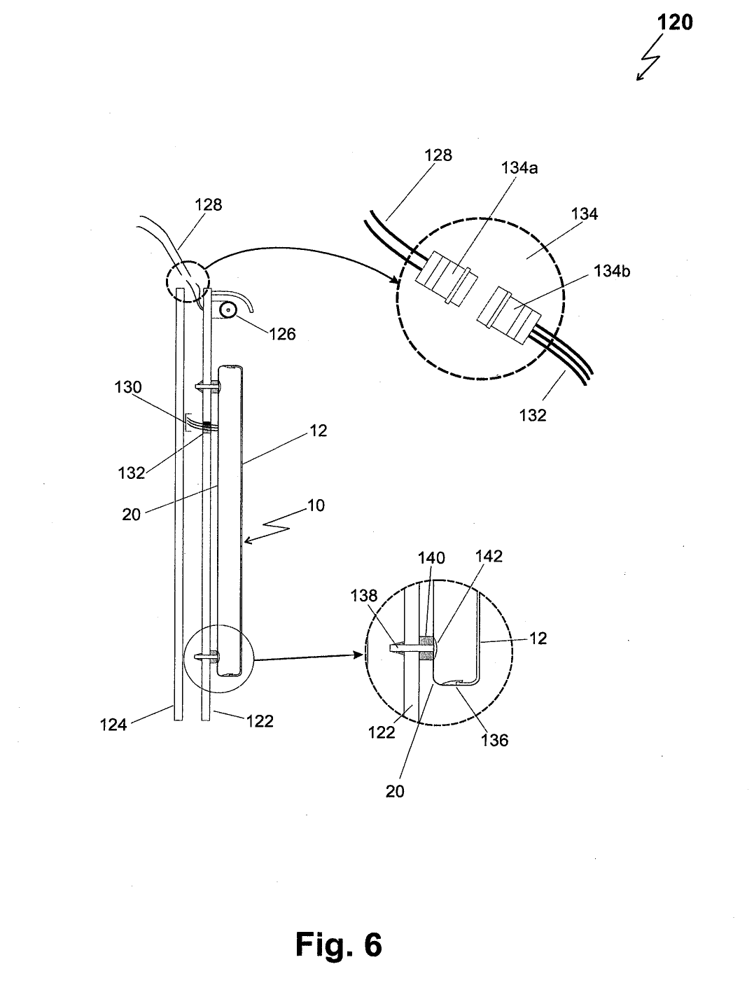

With reference now to FIG. 6, an appreciation can be obtained of the structure and methodology of retrofitting an interactive license plate assembly 10 to an existing vehicle. Such a retrofit structure is designated generally by the numeral 120. As shown, the interactive license plate assembly 10 is affixed to the exterior trunk wall 122, at the location that previously received a standard passive license plate. The illustration of FIG. 6 shows an exterior trunk wall 122 and an interior trunk wall 124, which is typical of most vehicles at this location, although it will be appreciated that a single wall 122 might be present.

Typically, above the license plate location, there is a plate illumination system 126, no longer required because of the active nature of the plate assembly 10, employing an LED display 16. The pair of wires 128 typically employed with the plate illumination assembly 126 includes a power line and a ground line, both of which are cut during the retrofit process. Included as a portion of the plate assembly 10 are three wires 130, comprising a power line, a ground line, and a security wire for evidencing tampering, cut wires, and the like. These three wires 130 pass through an aperture 132 which may be drilled through the exterior wall 122 of the trunk. A connector assembly 134 is provided as part of the retrofit structure. The connector assembly 134 includes mating sections 134a and 134b. The power and ground wires 128 are connected to the section 134a, while the wires 132, including power, ground and safety wires, are connected to the element 134b. When the connection is made between mating portions 134a and 134b, the vehicle battery and electrical system pass power to the digital plate assembly 10 as will be apparent to those skilled in the art.

As shown in FIG. 6, the plate assembly 10 also includes a permanent locking case joint 136 that includes mating male and female portions that are at the outer edges of the frame 12 and circuit board 20, to permanently physically secure the integrity of the plate assembly 10. The frame 12 is snapped into place by means of the joint 136 after the circuit board 20, photovoltaic cell plate 18, LED display 16 and protective cover 14 are put in place. This all follows the attachment of the circuit board 20 to the exterior trunk wall 122 by means of expandable mounting studs 138, passing through the exterior trunk wall 122 at the existing plate mounts 140. In many vehicles, there are four such existing plate mounts. Where that is not the case, and only two exist, a second pair of plate mounts 140 will need to be drilled or provided.

The expandable mounting studs 138 each include a head 142 contacting ground provided by the metallic exterior trunk wall 122 and the circuit board 20. It will be appreciated that the expandable mounting stud 138 constitutes an electrical conductor, interconnecting electrical ground of the wall 122 with an appropriate circuit path of the circuit board 20 through the head 142 of the mounting stud 138. Accordingly, any attempt to remove the plate assembly 10 from the wall 122, will necessarily interrupt the circuit path to ground, effecting a signal of attempted removal. This signal can then be transmitted as to the control server 26, or otherwise. Upon such determination of disabling or tampering, the plate 10 may be appropriated disabled or an appropriate message may be displayed—both requiring corrective action by a licensed professional.

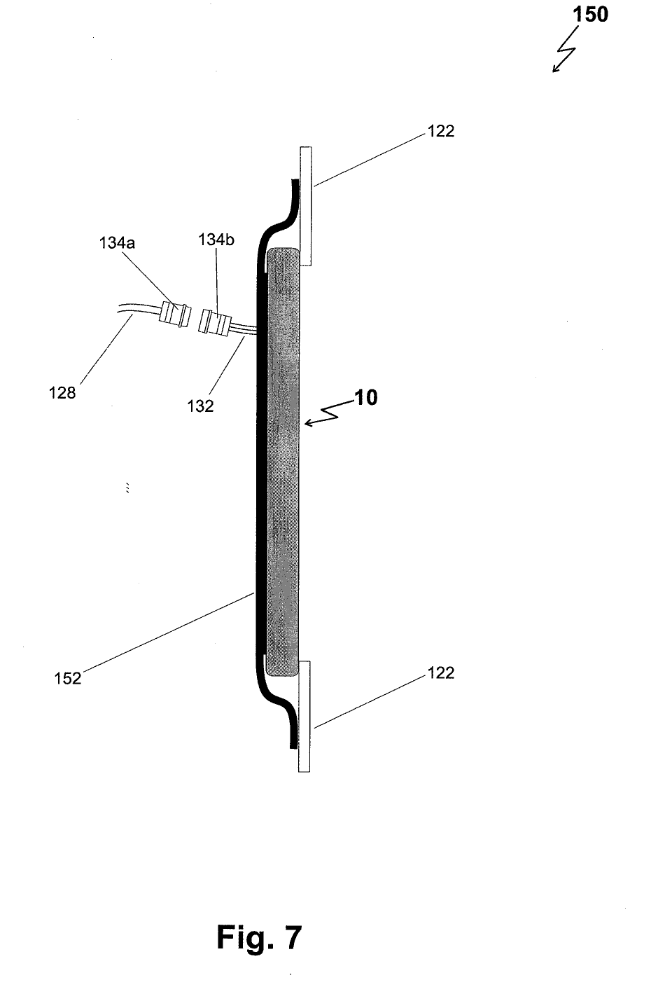

As shown in FIG. 7, the plate assembly 10 may be provided as an integral portion of a vehicle, as designated by the numeral 150. Here, the interactive license plate assembly 10 is provided within an opening of the exterior trunk wall 122 and is fixedly maintained therein by means of an appropriate mounting plate 152 which can be tack welded or otherwise permanently affixed to the wall 122. Again, the wires 128 to the vehicle electrical system are connected to the connector portion 134a, while the three wires 132 to the plate assembly 10 are connected to the connector portion 134b. When the connector portions 134a, 134b are matingly interconnected, any attempt to disconnect the connector 134, or otherwise severe the wires 132 will result in an event transmitted to the control server and transmission of the same to an appropriate agency or the like as through the control server 26.

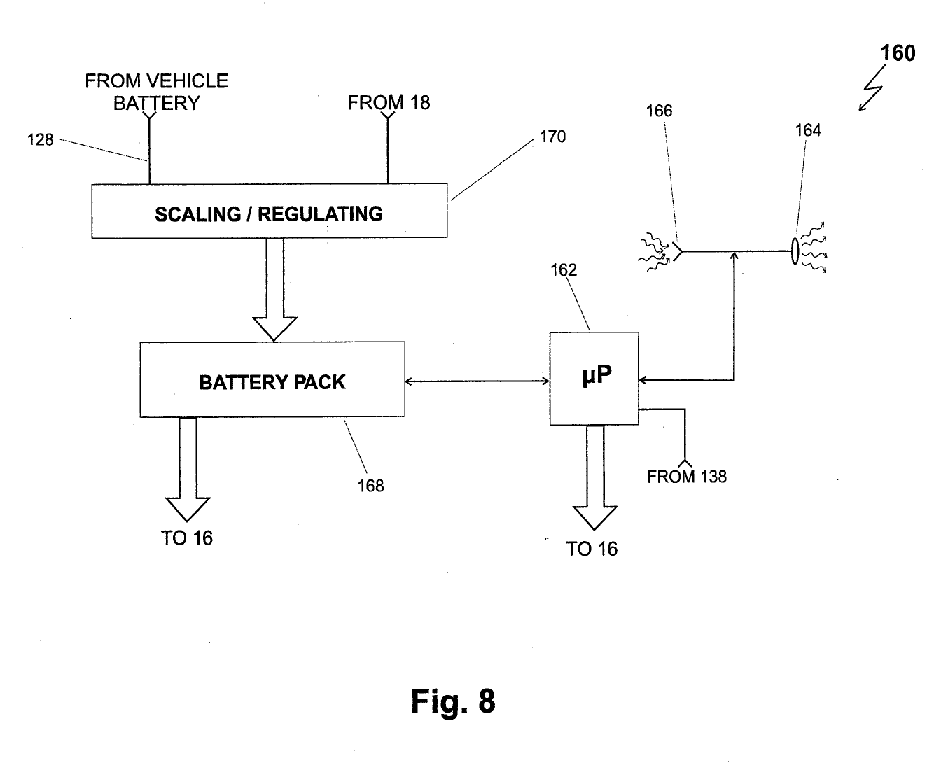

With reference now to FIG. 8, an appreciation can be obtained as to the basic circuitry required for operation of the interactive license plate assembly 10. The block circuit schematic 160 of FIG. 8 includes a dedicated microprocessor chip 162 as its central portion, the chip 162 communicating with an appropriate transponder, radio frequency or otherwise, including a transmitter 164 and a receiver 166. The transponder 164, 166 allows for communication with the control server 26 and the associated peripherals 28-34, described above. The microprocessor 162 is powered by a battery pack 168, which is maintained through a scaling/regulating circuit 170 by a combination of the battery from the vehicle and the solar panel 18. The battery pack, as shown, also connects to and drives the LED display 16. In like manner, selective actuation and control of the LED display 16 is under control of the microprocessor chip 162, which also receives communication from the mounting stud 138 and circuit board 20 to emit an appropriate signal to necessary authorities or agencies in the event of tampering. Similar signals are provided by the microprocessor chip 162 in the event that any attempt is made to separate the plate assembly 10 from the vehicle, resulting in severing of the wires 128.

Thus it can be seen that the various aspects of the invention have been obtained by the structure and method presented and described above. While in accordance with the patent statutes only the best mode and preferred embodiment of the invention has been presented and described in detail, it will be appreciated that the invention is not limited thereto or thereby. Accordingly, for an appreciation of the true scope and breadth of the invention reference should be made to the following claims.

What is claimed is:

1. An electronic license plate and information processing system, comprising:
a license plate assembly adapted for secured attachment to a vehicle;
at least one data and command source;
a control server interposed between said license plate assembly and said at least one data and command source, said control server effecting transmission of data and commands with said license plate assembly and said data and command source; and
wherein said license plate assembly is dynamic and interactive, responding to data and commands from said data and command source through said control server to effect a controlled publication thereon.

2. The electronic license plate and information processing system as recited in claim 1, wherein said license plate assembly comprises a display plate of discrete elements selectively illuminated by said data and command source through said control server.

3. The electronic license plate and information processing system as recited in claim 2, wherein said discrete elements comprise light emitting diodes.

4. The electronic license plate and information processing system as recited in claim 1, wherein said license plate assembly further comprises an electronic circuit board controlling said discrete elements to effect a desired display, a rechargeable battery pack to power said electronic circuit board and discrete elements, and a photovoltaic cell plate operatively connected to said rechargeable battery pack and electronic circuit board.

5. The electronic license plate and information processing system as recited in claim 4, wherein said electronic circuit board further comprises at least one transmitter and receiver for the transmission and receipt of data and command signals and a processor chip interposed between said transmitter and receiver and said display plate.

6. The electronic license plate and information processing system as recited in claim 1, further comprising a plurality of data and command sources and wherein said data and command sources are taken from the group comprising law enforcement, insurance data, a department of motor vehicles and public service agencies.

7. The electronic license plate and information processing system as recited in claim 6, further comprising a first encoder interposed between said control server and data and command sources for encrypting transmission of data and commands therebetween.

8. The electronic license plate and information processing system as recited in claim 7, further comprising a second encoder interposed between said license plate assembly and said control server for encrypting transmission of data and commands therebetween.

9. The electronic license plate and information processing system as recited in claim 1, wherein said control server receives data or commands from an insurance database and causes said license plate assembly to publish a message corresponding to a status of insurance coverage of the vehicle.

10. The electronic license plate and information processing system as recited in claim 1, wherein said control server receives data or commands from a law enforcement agency and causes said license plate assembly to publish a message corresponding to an activity or status associated with the vehicle.

11. The electronic license plate and information processing system as recited in claim 1, wherein said control server effects communication between said license plate assembly and a department of motor vehicles and causes said license plate assembly to publish a plate identification number, unique to the vehicle, said published plate identification number being recorded with the department of motor vehicles.

12. The electronic license plate and information processing system as recited in claim 11, wherein said plate assembly further comprises a static display of said plate identification number.

13. The electronic license plate and information processing system as recited in claim 1, wherein said control server receives data or commands from a public service agency and causes said license plate assembly to publish a temporal message on behalf of the public service agency.

14. A method for regulating and controlling the publication of information on a dynamic interactive vehicle license plate, comprising;
transmitting information from an information source to a control server;
transmitting said information from said control server to the dynamic interactive vehicle license plate; and
publishing a display on said dynamic interactive vehicle license plate in response to said information.

15. The method for regulating and controlling the publication of information on a dynamic interactive vehicle license plate as recited in claim 1, further comprising the steps of encrypting said information transmitted to and from the control server.

16. The method for regulating and controlling the publication of information on a dynamic interactive license plate as recited in claim 15, wherein said step of publishing a display comprises selectively illuminating light emitting diodes in a matrix of light emitting diodes.

17. The method for regulating and controlling the publication of information on a dynamic interactive license plate as recited in claim 14, further comprising the step of said dynamic interactive vehicle license plate confirming to said information source receipt of said information.

18. The method for regulating and controlling the publication of information on a dynamic interactive license plate as recited in claim 17, wherein said information source comprises a department of motor vehicles, and said step of transmitting information comprises the step of transmitting to said control server a plate identification number unique to an associated vehicle, and said step of publishing a display publishes said plate identification number on the dynamic interactive vehicle license plate.

19. The method for regulating and controlling the publication of information on a dynamic interactive license plate as recited in claim 18, further comprising the step of the department of motor vehicles registering the plate identification number to the associated vehicle.

20. The method for regulating and controlling the publication of information on a dynamic interactive license plate as recited in claim 17, wherein said information source is taken from the group of insurance record data, law enforcement, and public service agencies, and wherein said step of publishing a display comprises temporally presenting a display on the dynamic interactive vehicle license plate specific to said source.

21. The method for regulating and controlling the publication of information on a dynamic interactive license plate as recited in claim 17, wherein said information source comprises a Global Positioning System.

22. The method for regulating and controlling the publication of information on a dynamic interactive license plate as recited in claim 14, further comprising the step of monitoring said license plate for tampering, and transmitting information through said control server to an agency of concern in the event tampering is sensed.
